(19) United States
(12) Patent Application Publication
(10) Pub. No.: US 2026/0120449 A1
(43) Pub. Date: Apr. 30, 2026

(54) METHOD AND SYSTEM FOR REAL-TIME ADAPTATION OF DEEP LEARNING MODEL BASED ON BLOCK SELECTION AND TEACHER MODEL

(71) Applicant: GWANGJU INSTITUTE OF SCIENCE AND TECHNOLOGY, Gwangju (KR)

(72) Inventors: Kyoobin LEE, Gwangju (KR); Min Hwan KO, Gwangju (KR); Seung Hyeok BACK, Gwangju (KR); Sung Ho SHIN, Gwangju (KR); Yeon Guk YU, Gwangju (KR); Sang Jun NOH, Gwangju (KR)

(73) Assignee: GWANGJU INSTITUTE OF SCIENCE AND TECHNOLOGY, Gwangju (KR)

(21) Appl. No.: 19/003,696

(22) Filed: Dec. 27, 2024

(30) Foreign Application Priority Data
Jun. 26, 2024 (KR) 10-2024-0083249

(51) Int. Cl. G06V 10/82; G06N 3/0895; G06V 10/74; G06V 10/774

(52) U.S. Cl. CPC G06V 10/82; G06N 3/0895; G06V 10/761; G06V 10/774

(57) ABSTRACT

A method of real-time adaptation of a deep learning model is provided. The method includes: receiving training data further provided for a pre-trained deep learning model; identifying, among a plurality of blocks included in the deep learning model, one or more blocks having a learning impact due to entropy change that is less than a predetermined level; training the one or more blocks using the training data so that entropy for a class corresponding to the training data is minimized; and retraining the deep learning model using the training data based on a pre-trained teacher model.

### DESCRIPTION OF GOVERNMENT-SPONSORED RESEARCH

The present invention was carried out with support from the national research and development project, with the unique project identification number being 1711193916 and the project number being 2022-0-00951-002. The project related to the present invention is supervised by the Ministry of Science and ICT, and managed by the Institute of Information and Communications Technology Planning and Evaluation (IITP). The research project is titled “Human-centered Artificial Intelligence Core Technology Development Project,” and the research project is named “Development Of Agent Technology That Grows By Recognizing Its Own Uncertainty And Asking Questions.” The project executing institution is the Electronics and Telecommunications Research Institute (ETRI), and the research period is from Jan. 1, 2023, to Dec. 31, 2023.

### CROSS REFERENCE TO RELATED APPLICATION

The present application claims priority to Korean Patent Application No. 10-2024-0083249, filed on Jun. 26, 2024, the entire contents of which is incorporated herein for all purposes by this reference.

### BACKGROUND

### Field

The present invention relates to a method and system for real-time adaptation of a deep learning model based on block selection and a teacher model.

### Description of the Related Art

With the advancement of artificial intelligence-related technologies, there has been active research on the test time adaptation (TTA) technique, which allows the pre-trained deep learning model to adapt to new classes after the training on the deep learning model is completed and deployed, even without accessing the data used for the previous training.

For example, in case of TENT, during the process of further training a training-completed deep learning model with a new class, the training proceeds in a manner that reduces the probability of detecting previously learned classes in images corresponding to the new class.

Additionally, in case of CoTTA, during the process of further training a training-completed deep learning model with a new class, the images corresponding to the new class are augmented in various ways. This allows the model to perform training on the new class with a greater amount of training data than originally provided.

### SUMMARY

The present invention relates to a method and system for real-time adaptation of a deep learning model based on block selection and a teacher model, which is capable of preventing a decrease in the reliability of the deep learning model arising from an additional training result by the amount of training data, while preserving the previously learned performance.

In addition, the present invention relates to a method and system for real-time adaptation of a deep learning model based on block selection and a teacher model, which is capable of more effectively enhancing the performance of the deep learning model.

To solve the aforementioned objects, there is provided a method of real-time adaptation of a deep learning model using a system for real-time adaptation of a deep learning model, according to the present invention. The method may include: receiving training data further provided for a pre-trained deep learning model; identifying, among a plurality of blocks included in the deep learning model, one or more blocks having a learning impact due to entropy change that is less than a predetermined level; training the one or more blocks using the training data so that entropy for a class corresponding to the training data is minimized; and retraining the deep learning model using the training data based on a pre-trained teacher model.

In addition, there is provided a system for real-time adaptation of a deep learning model, according to the present invention. The system may include: an input unit configured to receive training data further provided for a pre-trained deep learning model; and a control unit configured to perform further training of the deep learning model using the training data, in which the control unit may identify one or more blocks, among a plurality of blocks included in the deep learning model, where a learning impact due to entropy changes is less than a predetermined level, train the one or more blocks using the training data so that entropy corresponding to a class corresponding to the training data is minimized, and retrain the deep learning model using the training data based on a pre-trained teacher model.

In addition, there is provided a program stored on a computer-readable recording medium, and executed by one or more processes in an electronic device, according to the present invention. The program may include instructions to allow the program to perform: receiving training data further provided for a pre-trained deep learning model; identifying, among a plurality of blocks included in the deep learning model, one or more blocks having a learning impact due to entropy change that is less than a predetermined level; training the one or more blocks using the training data so that entropy for a class corresponding to the training data is minimized; and retraining the deep learning model using the training data based on a pre-trained teacher model.

According to various embodiments of the present invention, the method and system for real-time adaptation of a deep learning model based on block selection and a teacher model may select and train one or more blocks, among the plurality of blocks included in the deep learning model, in which the learning impact due to entropy change is less than a predefined level. This process allows for the preservation of the performance learned previously, while preventing a decrease in the reliability of the deep learning model arising from the additional learning results due to the amount of training data.

In addition, according to various embodiments of the present invention, the method and system for real-time adaptation of a deep learning model based on block selection and a teacher model can further enhance the performance of the deep learning model by retraining the deep learning model, in which a specific block is trained based on the teacher model.

### BRIEF DESCRIPTION OF THE DRAWINGS

FIG. 1 illustrates an embodiment of a system for real-time adaptation of a deep learning model according to the present invention.

FIG. 2 and FIG. 3 illustrate an embodiment of selecting a block for which the learning impact due to entropy change is less than a predetermined level.

FIG. 4 illustrates an embodiment of training a deep learning model using a teacher model.

FIG. 5 illustrates a system for real-time adaptation of a deep learning model according to the present invention.

FIG. 6 is a flowchart illustrating a method of real-time adaptation of a deep learning model according to the present invention.

FIG. 7 illustrates an embodiment of receiving training data.

FIG. 8 and FIG. 9 illustrate an embodiment of selecting a block for which the learning impact due to entropy change is less than a predetermined level.

FIG. 10 illustrate an embodiment of training a block for which the learning impact due to entropy change is less than a predetermined level.

FIG. 11 illustrates an embodiment of acquiring output data for a training data pair using a teacher model.

FIG. 12 illustrates an embodiment of training a deep learning model using output data output by a teacher model.

FIG. 13 is a block diagram illustrating the structure of a computing device performing a method of real-time adaptation of a deep learning model of the present invention.

### DETAILED DESCRIPTION OF EMBODIMENTS

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The suffixes “module”, “unit”, “part”, and “portion” used to describe constituent elements in the following description are used together or interchangeably in order to facilitate the description, but the suffixes themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be interpreted that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element exists between the constituent elements.

Singular expressions include plural expressions unless clearly described as different meanings in the context.

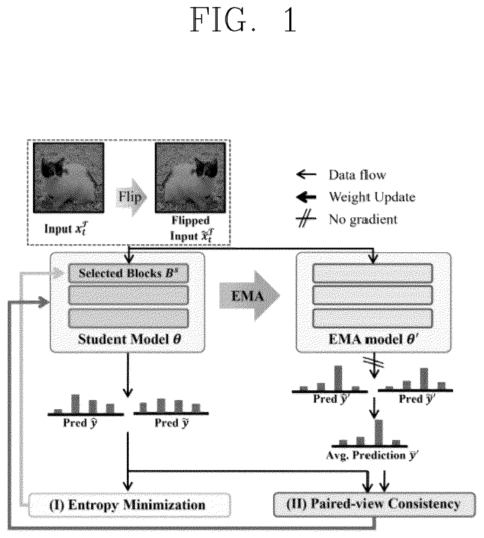

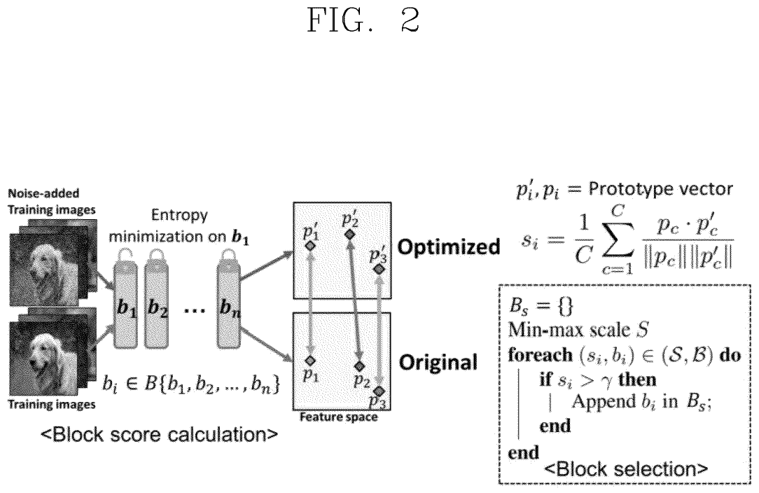

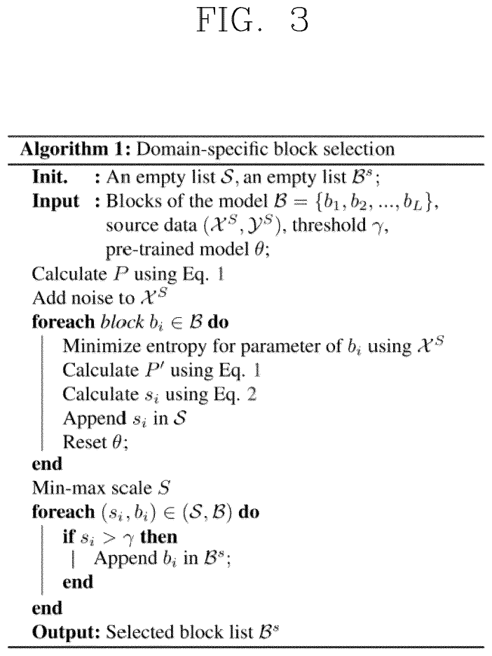

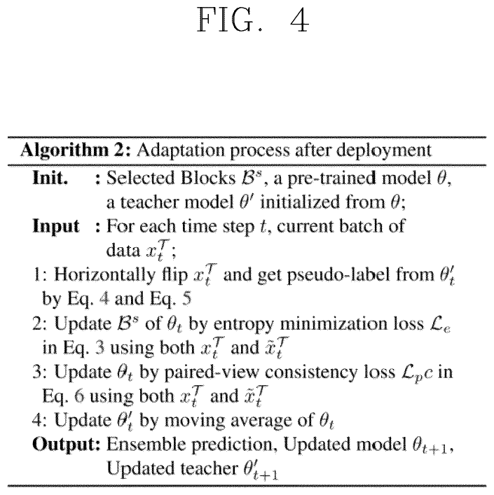

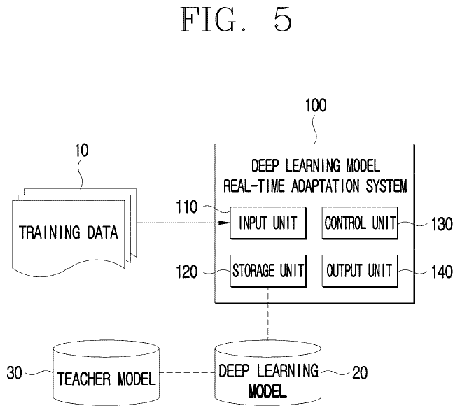

In the present application, it should be understood that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance. FIG. 1 illustrates an embodiment of a system for real-time adaptation of a deep learning model according to the present invention. FIG. 2 and FIG. 3 illustrate an embodiment of selecting a block for which the learning impact due to entropy change is less than a predetermined level. FIG. 4 illustrates an embodiment of training a deep learning model using a teacher model. FIG. 5 illustrates a system for real-time adaptation of a deep learning model according to the present invention.

With reference to FIG. 1, a system 100 for real-time adaptation of a deep learning model (hereinafter referred to as a “deep learning model real-time adaptation system”) according to the present invention may perform real-time adaptation on a pre-trained deep learning model (e.g., a student model) for additionally provided training data (e.g., input).

To this end, the deep learning model real-time adaptation system 100 identifies a block among a plurality of blocks included in the deep learning model, where the learning impact due to the entropy change is less than a predetermined level. The system may then train the previously identified block using training data so that the entropy for the class corresponding to the training data is minimized (e.g., Entropy Minimization). Additionally, the system may retrain the training data based on a pre-trained teacher model (e.g., EMA model) (e.g., Paired-view Consistency).

Here, the additionally provided training data may include training images provided after the deployment of the deep learning model, as well as ground truth data, which is the label data for the training images.

In this case, the training data may also include test data, where this test data is formed by classifying at least a portion of the training images from the training data, and may be used to validate the deep learning model trained based on the training data.

The ground truth data may include information related to one or more classes that the deep learning model is to recognize from images through training, and, in an embodiment, may include bounding boxes set on at least a partial area of the training image. In this case, one or more classes included in the ground truth data may be different from the one or more classes learned during the pre-training process of the deep learning model.

The deep learning model may have been pre-trained and deployed. That is, when a predetermined image is input, the deep learning model may be trained using pre-training data to recognize (or classify) a pre-trained class from the input image.

In this case, the pre-training data may include pre-training images and pre-ground truth data, which is the label data for the pre-training images. In addition, the pre-training data may also include pre-test data, where this pre-test data is formed by classifying at least a portion of the pre-training images from the pre-training data, and may be used to validate the deep learning model that has been pre-trained based on the pre-training data.

The pre-ground truth data includes information related to one or more classes that the deep learning model is to recognize from images through pre-training, and may include bounding boxes set on at least a partial area of the pre-training images.

Accordingly, when such a deep learning model is deployed after the completion of pre-training, the deep learning model may operate to recognize pre-trained classes from a predetermined image.

In this regard, depending an embodiment, the deep learning model real-time adaptation system 100 may train the deep learning model using the pre-training data and may select a block of the trained deep learning model where the learning impact due to entropy change is less than a predetermined level.

Meanwhile, the deep learning model may extract feature vectors from an image through a plurality of pre-trained blocks and predict the entropy for one or more pre-trained classes based on the extracted feature vectors.

That is, a block may include one or more layers implemented to extract feature vectors from an image and, depending on an embodiment, may refer to a specific layer.

In addition, the entropy may represent the uncertainty of the probability that the feature vector extracted from the block corresponds to each class. For example, the entropy decreases as the probability that the feature vector extracted from the block corresponds to a specific class becomes greater than the probability that it corresponds to other classes. Conversely, the entropy increases as the probability that the feature vector extracted from the block corresponds to a specific class becomes equal to the probability that it corresponds to other classes.

Accordingly, training a block so that entropy is minimized may involve training a specific block to reduce the probability that a predetermined image is recognized as a class other than a predetermined specific class.

In addition, selecting a block where the learning impact due to entropy change is less than a predetermined level may involve selecting a block where, during the process of training for a specific class, when an arbitrary block is trained to minimize entropy for the corresponding class, the change in the feature vector extracted from the image (or the probability of each class for the feature vector) before and after training is less than a predetermined level.

In this case, selecting a block where the learning impact due to entropy change is less than a predetermined level may involve, as illustrated in FIG. 2 and FIG. 3, selecting a block where, when an arbitrary block is trained to minimize entropy by inputting a noise image in which a predetermined noise is added to the original image (e.g., pre-training data or training data) into the deep learning model, the change in the feature vector (or the probability of each class for the feature vector) extracted from the original image and the noise image is less than the predetermined level.

Such block selection may be carried out during the process of pre-training the deep learning model (or testing according to the pre-training). In addition, depending on an embodiment, block selection may be performed to reselect a block with a learning impact due to entropy change that is less than a predetermined level during the process of performing real-time adaptation based on additional training data.

Meanwhile, the teacher model is a pre-trained model and may be a model that has been pre-trained based on a large-scale dataset. The teacher model, depending on an embodiment, may also be a model trained based on the pre-training data and the training data.

Such a teacher model may be implemented with the same structure as the deep learning model or may have a more complex structure compared to the deep learning model, to perform more precise analysis.

Accordingly, the deep learning model real-time adaptation system 100 may input the additionally provided training data into the teacher model to acquire output data for the input training data, and may label and use the training data with the output data acquired through the teacher model as ground truth data.

Here, the output data may include the probability for each class predicted by the teacher model for the training images included in the training data.

Accordingly, the deep learning model real-time adaptation system 100 may train the deep learning model using the training images and output data acquired through the teacher model. That is, the deep learning model real-time adaptation system 100 may be understood as training the deep learning model as a student model corresponding to the teacher model.

In this case, as illustrated in FIG. 4, the deep learning model real-time adaptation system 100 may replicate the training data (e.g., flip) to generate a replicated image, input the training data pair consisting of the training data and the replicated image into the teacher model to acquire output data for the training data pair, and label the training data with the acquired output data as pseudo ground truth data. The system may then train the deep learning model using the training data and the pseudo ground truth data.

To this end, with reference to FIG. 5, the deep learning model real-time adaptation system 100 according to the present invention may include an input unit 110, a storage unit 120, a control unit 130, and an output unit 140.

The input unit 110 may receive information necessary for the operation of the deep learning model real-time adaptation system 100 according to the present invention as input. To this end, the input unit 110 may be connected to a separate input device, server, or external storage device via a wireless or wired network.

Accordingly, the input unit 110 may receive the training data 10 from a separate input device, server, external storage device, or the like. In this regard, the input unit 110 may also receive pre-training data when the deep learning model real-time adaptation system 100 performs pre-training for a deep learning model 20.

In addition, the input unit 110 may also receive predetermined user commands. When the teacher model 30, depending on an embodiment, is provided in a separate server or an external device, the input unit 110 may also receive output data corresponding to the training data 10 from the server or external device in which a teacher model 30 is provided.

In addition, the storage unit 120 may store instructions and information necessary for the operation of the deep learning model real-time adaptation system 100 according to the present invention. For example, the storage unit 120 may store the deep learning model 20. In this case, the storage unit 120 may also store the teacher model 30, depending on an embodiment.

In addition, the storage unit 120 may store at least one of the pre-training data, training data 10, and output data input through the input unit 110. In addition, the storage unit 120 may store various types of data generated during the process of training the deep learning model 20 by the control unit 130.

The control unit 130 may control the overall operation of the deep learning model real-time adaptation system 100 according to the present invention. That is, the control unit 130 may identify one or more blocks among the plurality of blocks included in the deep learning model 20, where the learning impact due to entropy change is less than a predetermined level. The control unit 130 may then perform training of the previously identified blocks so that the entropy for the class corresponding to the training data 10 is minimized and may retrain the deep learning model 20 using the training data 10 based on the teacher model 30.

In addition, depending on an embodiment, the control unit 130 may perform pre-training of the deep learning model 20 using the pre-training data and may acquire output data corresponding to the training data 10 (or training data pair) using the teacher model 30.

The output unit 140 may output the information generated by the operation of the deep learning model real-time adaptation system 100 according to the present invention. To this end, the output unit 140 may be connected to a separate visual output device, server, external storage device, or the like via a wireless or wired network.

Accordingly, the output unit 140 may output the deep learning model 20 and the data generated during the training and testing process of the deep learning model 20 through a separate output device, server, external storage device, or the like.

In this case, outputting predetermined data from the output unit 140 may involve delivering specific data to a server or external storage device or outputting predetermined data through a separate output device so that a user may visually identify the data.

Based on the configuration of the deep learning model real-time adaptation system 100 described above, a method of real-time adaptation of a deep learning model will be described in more detail below.

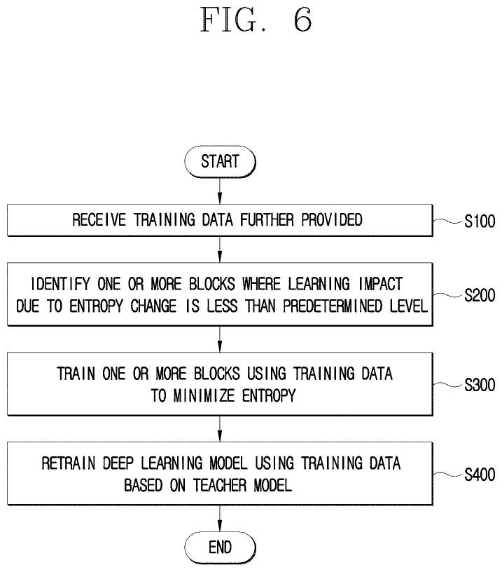

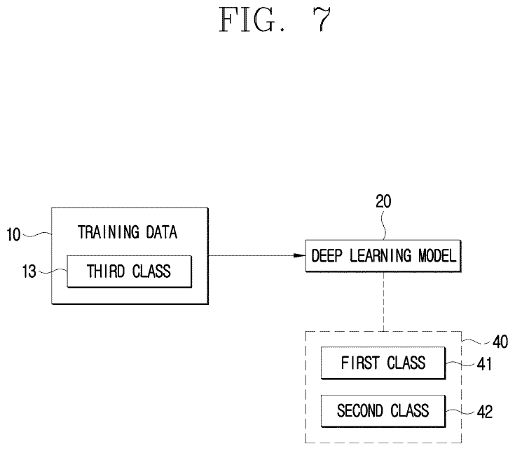

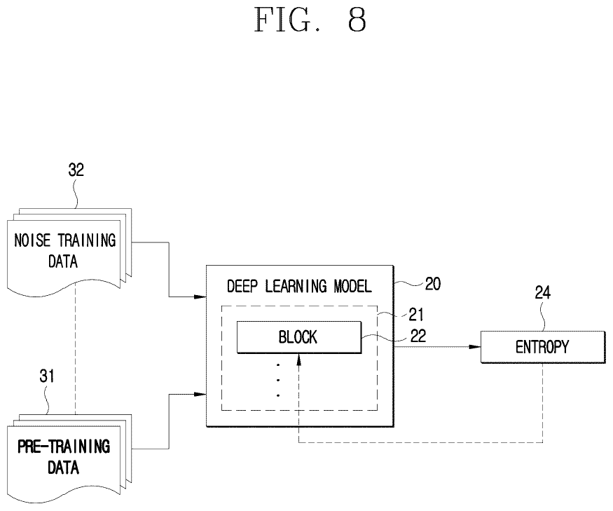

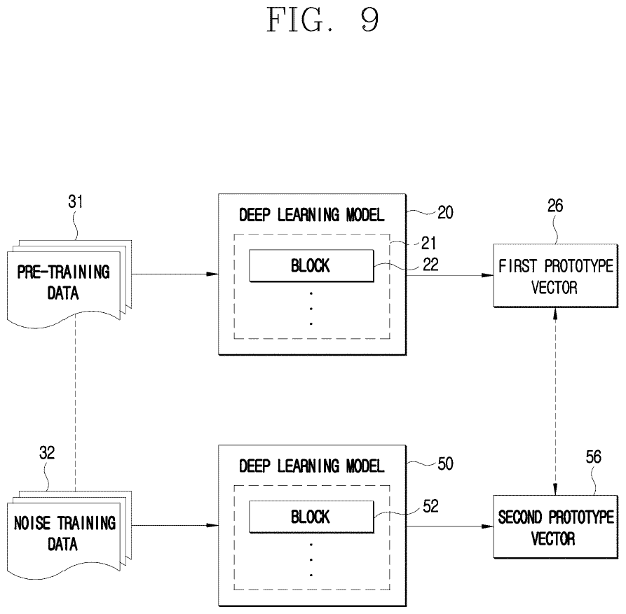

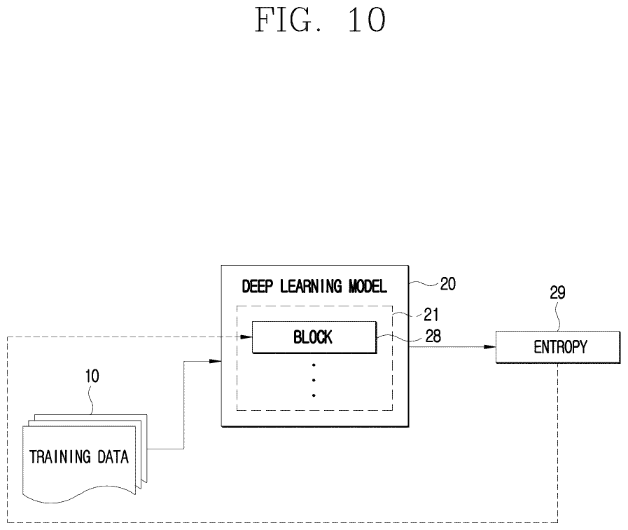

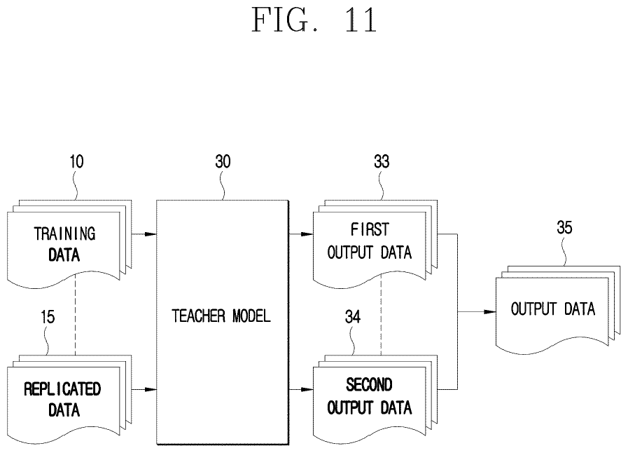

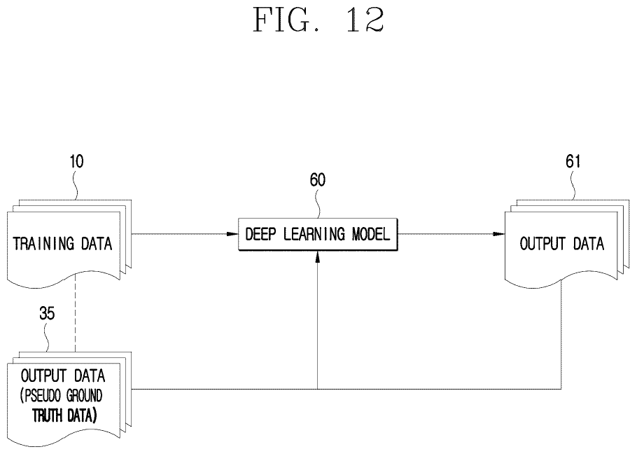

FIG. 6 is a flowchart illustrating a method of real-time adaptation of a deep learning model according to the present invention. FIG. 7 illustrates an embodiment of receiving training data. FIG. 8 and FIG. 9 illustrate an embodiment of selecting a block for which the learning impact due to entropy change is less than a predetermined level. FIG. 10 illustrate an embodiment of training a block for which the learning impact due to entropy change is less than a predetermined level. FIG. 11 illustrates an embodiment of acquiring output data for a training data pair using a teacher model. FIG. 12 illustrates an embodiment of training a deep learning model using output data output by a teacher model.

With reference to FIG. 6, the deep learning model real-time adaptation system 100 according to the present invention may receive additional training data for the pre-trained deep learning model (S100) and identify one or more blocks among the plurality of blocks included in the deep learning model, where the learning impact due to entropy change is less than a predetermined level (S200).

Specifically, the deep learning model real-time adaptation system 100 may receive training data that is intended to additionally train the deep learning model, which has already been trained to recognize pre-trained classes from a predetermined image using pre-training data, with one or more classes different from the pre-trained classes.

For example, with reference to FIG. 7, the deep learning model real-time adaptation system 100 may receive training data 10 for a third class 13 for the deep learning model 20, which has already been trained to recognize a first class 41 and a second class 42 from a predetermined image.

In this case, the training data 10 may be provided to enable the deep learning model 20 to learn one or more classes (e.g., third class 13), and the trained deep learning model 20 may be trained based on the pre-training data 40.

Further, during the pre-training process before the deployment of the deep learning model, the deep learning model real-time adaptation system 100 may individually train each of the plurality of blocks included in the deep learning model to minimize entropy for the deep learning model, thereby identifying one or more blocks with the learning impact due to entropy minimization that is less than a predetermined level.

For example, with reference to FIG. 8, the deep learning model real-time adaptation system 100, before the deep learning model 20 is deployed after having been trained using pre-training data 31 (or training data), may extract a feature vector (hereinafter referred to as a “first feature vector”) from a predetermined image (e.g., a test image) and predict the probability for each class (hereinafter referred to as a “first probability”) based on the extracted feature vector.

Subsequently, the deep learning model real-time adaptation system 100 may insert predetermined noise into the pre-training data 31 (or training data) to generate noise training data 32. For each of the plurality of blocks 21, the system may perform training so that the entropy for one or more classes is minimized based on the noise training data 32. Based on the deep learning model 20 that has completed training for one or more blocks 22, the system may extract a feature vector (hereinafter referred to as a “second feature vector”) from a predetermined image (e.g., a test image) and predict the probability for each class (hereinafter referred to as a “second probability”) based on the extracted feature vector.

That is, the first feature vector and the first probability may be data output from the deep learning model 20 after pre-training (or additional training) is completed, while the second feature vector and the second probability may be data output from a model in which the entropy for one or more blocks 22, among the plurality of blocks 21 included in the deep learning model 20, has been minimized.

In addition, the second feature vector and the second probability may be predicted for each of the plurality of blocks 21 included in the deep learning model 20. That is, when the deep learning model 20 includes N blocks 21, the deep learning model 20 may train one or more blocks 22 among the N blocks 21 so that entropy is minimized. By repeating the process of predicting the second feature vector and the second probability from a predetermined image based on the deep learning model 20 that has completed training for the corresponding block 22, it is possible to predict N second feature vectors and second probabilities.

In this case, the first feature vector and the first probability may be data acquired based on the pre-training data 31 (or training data), while the second feature vector and the second probability may be data acquired based on the noise training data 32 in which noise is inserted.

Accordingly, the deep learning model real-time adaptation system 100 may compare the data output from the deep learning model 20 after the pre-training (or additional training) is completed with the data output from the model in which one or more blocks 22 among the plurality of blocks 21 included in the deep learning model 20 are trained to minimize entropy. Based on the comparison result, the system may select a block with the learning impact due to entropy minimization that is less than a predetermined level.

That is, a block with the learning impact due to entropy minimization that is less than a predetermined level may be selected based on the comparison between the data output from the deep learning model 20 after pre-training (or additional training) is completed and the data output from the model in which one or more blocks 22 among the plurality of blocks 21 included in the deep learning model 20 have been trained to minimize entropy.

In an embodiment, the deep learning model real-time adaptation system 100 may select one or more blocks among the plurality of blocks, where a difference between the first probability and the second probability is less than a predetermined level, as blocks with the learning impact due to entropy minimization that is less than a predetermined level.

In another embodiment, the deep learning model real-time adaptation system 100 may also select one or more blocks among the plurality of blocks, where a difference between the first feature vector and the second feature vector is less than a predetermined level, as blocks with the learning impact due to entropy minimization that is less than a predetermined level. In this case, a block with the learning impact due to entropy minimization that is less than a predetermined level may be a block where a cosine similarity between the first feature vector and the second feature vector is higher than a predetermined threshold.

In another embodiment, the deep learning model real-time adaptation system 100 may calculate a prototype vector according to Equation 1 below and may select a block with the learning impact due to entropy minimization that is less than a predetermined level based on the calculated prototype vector.

$${P}_{c} = \frac{1}{{N}_{c}} {\sum }_{n = 1}^{{N}_{c}} f ( {x}_{n}^{c} ∈ {X}^{S} ; θ ) \qquad Equation 1$$

Here, P_{c} may represent a prototype vector, X^{S} may represent pre-training data (or training data or test data) for the deep learning model, and θ may represent the deep learning model itself.

In addition, f may represent a function for extracting features from an image,

$${x}_{n}^{c}$$

may represent an n-th image belonging to class c (e.g., an RGB image), and Ne may represent the number of images for class c.

Therefore, the deep learning model real-time adaptation system 100 may calculate the prototype vector for one or more pre-trained classes.

In this regard, with reference to FIG. 9, the deep learning model real-time adaptation system 100 may calculate a first prototype vector 26 from the pre-training data 31 (or training data) based on the original deep learning model 20. Then, based on a deep learning model where one or more blocks 52 have been trained to minimize entropy among the plurality of blocks, the system may calculate a second prototype vector 56 from the noise training data 32 (or pre-training data 31 and training data).

Accordingly, the deep learning model real-time adaptation system 100 may calculate a similarity between the first prototype vector 26 and the second prototype vector 56 according to Equation 2 as shown below.

$${s}_{i} = \frac{1}{C} {\sum }_{c = 1}^{C} \frac{{p}_{c} \cdot {p}_{c}^{′}}{‖ {p}_{c} ‖ ‖ {p}_{c}^{′} ‖} \qquad Equation 2$$

Here, sᵢ may represent a similarity between the first prototype vector 26 and the second prototype vector 56, C may represent the number of classes learned by the deep learning model 20, p_{c} may represent the first prototype vector 26 for a c-th class, and p_{c}′may represent the second prototype vector 56 for the c-th class.

Accordingly, the deep learning model real-time adaptation system 100 may normalize the calculated similarity for each of the plurality of blocks included in the deep learning model to a predetermined range (e.g., from 0 to 1). Among the normalized similarities, the system may select one or more blocks with a value greater than a predetermined threshold (e.g., 0.75) as blocks with the learning impact due to entropy minimization that is less than a predetermined level.

Alternatively, the deep learning model real-time adaptation system 100 may select a block with the highest calculated similarity as a block with the learning impact due to entropy minimization that is less than a predetermined level.

In this regard, when performing pre-training of the deep learning model, the deep learning model real-time adaptation system 100 may perform the process of selecting blocks among the plurality of blocks included in the deep learning model that have the learning impact due to entropy minimization that is less than a predetermined level. According to an embodiment, when the deep learning model has been pre-trained by a separate learning system, the deep learning model real-time adaptation system 100 may also identify the blocks with the learning impact due to entropy minimization that is less than a predetermined level as selected by the corresponding learning system.

Additionally, depending on an embodiment, when performing additional training of the deep learning model using the training data, the deep learning model real-time adaptation system 100 may perform the process of selecting blocks with the learning impact due to entropy minimization that is less than a predetermined level, as described above. This process allows the system to update the previously selected blocks with the learning impact due to entropy minimization that is less than a predetermined level for the deep learning model.

With reference back to FIG. 6, the deep learning model real-time adaptation system 100 according to the present invention may minimize the entropy in one or more of the previously identified blocks and train the deep learning model using the training data (S300).

Specifically, the deep learning model real-time adaptation system 100 may minimize the entropy for one or more blocks selected as blocks with the learning impact due to entropy minimization that is less than a predetermined level among the plurality of blocks included in the deep learning model.

For example, with reference to FIG. 10, the deep learning model real-time adaptation system 100 may input the training data 10 into the deep learning model 20 to extract a feature vector. The system may train a previously identified block 28 (or one or more blocks) so that the probability of the extracted feature vector being recognized as the class corresponding to the training data 10 (or ground truth data) is higher than the probability thereof being recognized as another class.

To this end, the deep learning model real-time adaptation system 100 may acquire the probability that the training data 10 is recognized as the class corresponding to the training data 10 through the deep learning model 20. The system may calculate entropy 29 of the acquired probability and train the previously identified block 28 so that the calculated entropy 29 is minimized.

In an embodiment, the deep learning model real-time adaptation system 100 may calculate the entropy 29 according to Equation 3 below.

$${L}_{e} = - {\sum }_{c} {\hat{y}}_{c} log {\hat{y}}_{c} \qquad Equation 3$$

Here, Lₑ may represent the Shannon entropy, and ŷ_{c} may represent the probability that the c-th class is output based on the training data 10 (or test data) from the deep learning model 20.

In this case, the deep learning model real-time adaptation system 100 may train only the previously identified block 28 (or one or more blocks) among the plurality of blocks 21 included in the deep learning model.

With reference back to FIG. 6, the deep learning model real-time adaptation system 100 according to the present invention may retrain the deep learning model using the training data based on a pre-trained teacher model (S400).

Specifically, the deep learning model real-time adaptation system 100 may replicate the training data to generate a training data pair, acquire output data for the training data pair using the teacher model, and label the training data with the acquired output data as pseudo ground truth data to train the deep learning model.

To this end, the deep learning model real-time adaptation system 100 may replicate the training data to generate replicated data, perform image processing on the replicated data, and generate a training data pair based on the image-processing performed replicated data and the original training data.

For example, the deep learning model real-time adaptation system 100 may replicate the training image included in the training data and generate replicated data by flipping the replicated image (e.g., left-right flip). In this case, depending on an embodiment, the deep learning model real-time adaptation system 100 may additionally add predetermined noise to the replicated image.

Accordingly, the deep learning model real-time adaptation system 100 may generate a training data pair by matching the training image with the replicated image.

Further, the deep learning model real-time adaptation system 100 may input the training data according to the training data pair into the teacher model to acquire first output data, input the image-processing performed replicated data according to the training data pair into the teacher model to acquire second output data, and calculate the output data for the training data pair based on the first output data and the second output data.

With reference to FIG. 11, for example, the deep learning model real-time adaptation system 100 may acquire first output data 33 and second output data 34 as shown in Equation 4 below.

$${\hat{y}}^{′} = g {θ}^{′} ( {x}_{t}^{T} ) \qquad Equation 4$$

$${\tilde{y}}^{′} = g {θ}^{′} ( {\tilde{x}}_{t}^{T} ) {\hat{y}}^{′} = g {θ}^{′} ( {x}_{t}^{T} )$$

$${\tilde{y}}^{′} = g {θ}^{′} ( {\tilde{x}}_{t}^{T} )$$

Here, gθ′ may represent the teacher model 30, ŷ′ may represent the first output data 33,

$${x}_{t}^{T}$$

may represent the training data 10, \tilde{y}′ may represent the second output data 34, and

$${\tilde{x}}_{t}^{T}$$

may represent replication data 15.

Accordingly, the deep learning model real-time adaptation system 100 may generate output data 35 for the training data pair 10 and 15 based on the first output data 33 and the second output data 34.

In an embodiment, the deep learning model real-time adaptation system 100 may calculate an average value of the first output data 33 and the second output data 34, and specify the calculated average value as the output data 35 for the training data pair 10 and 15.

In another embodiment, the deep learning model real-time adaptation system 100 may calculate the output data 35 for the training data pair 10 and 15 according to Equation 5 below.

$$\begin{matrix}{L}_{p c} = {L}_{s c e} ( {\hat{y}}^{′} , {\overline{y}}^{′} ) \\ {L}_{s c e} ( a , b ) = \frac{1}{2} \cdot ( {L}_{c e} ( a , b ) + {L}_{c e} ( b , a ) )\end{matrix} \qquad Equation 5$$

Here, L_{pc} may represent the symmetric cross entropy of the first output data 33 and the second output data 34, and L_{ce} may represent the loss of cross entropy or, the cross entropy error (CEE). In addition, L_{sce}(a, b) may be a parameter configured to calculate the symmetric cross entropy based on the loss of cross entropy.

Further, the deep learning model real-time adaptation system 100 may label the output data generated from the teacher model on the training data as pseudo ground truth data for the training data pair, and may train the deep learning model using the training data and the pseudo ground truth data.

With reference to FIG. 12, for example, the deep learning model real-time adaptation system 100 may input the training data 10 into a deep learning model 60, which has been trained on blocks with the learning impact due to entropy minimization that is less than a predetermined level, to acquire output data 61. The system may then compare the acquired output data 61 with the pseudo ground truth data 35 labeled on the training data 10, and train the deep learning model 60 so that the output data 61 conforms to (or mimics) the pseudo ground truth data 35.

In this case, the deep learning model real-time adaptation system 100 may train a plurality of blocks included in the deep learning model 60 using the training data 10 and the pseudo ground truth data 35.

Through the configurations as described above, the deep learning model real-time adaptation system 100 according to the present invention may select and train one or more blocks, among the plurality of blocks included in the deep learning model, in which the learning impact due to entropy change is less than a predefined level. This process allows for the preservation of the performance learned previously, while preventing a decrease in the reliability of the deep learning model arising from the additional learning results due to the amount of training data.

In addition, the deep learning model real-time adaptation system 100 according to the present invention may further enhance the performance of the deep learning model by retraining the deep learning model, in which a specific block is trained based on the teacher model.

Further, the deep learning model real-time adaptation system 100 according to the present invention is configured of a computing device, which may perform at least one function related to the aforementioned method of real-time adaptation of a deep learning model.

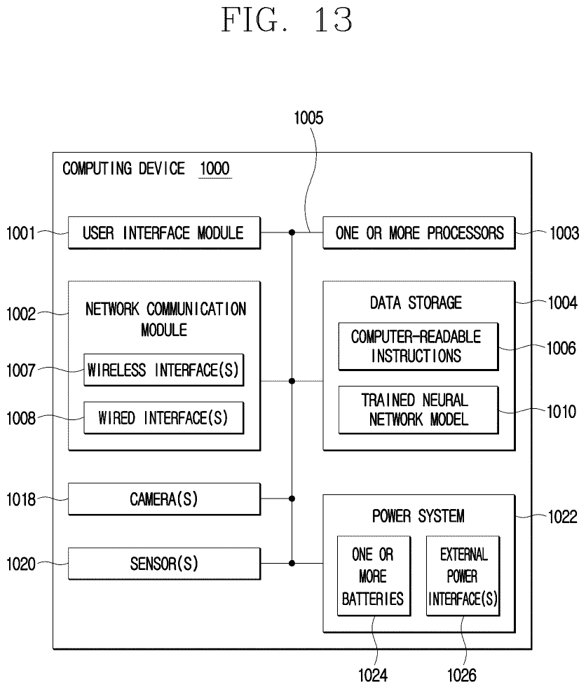

FIG. 13 is a block diagram illustrating the structure of a computing device performing a method of real-time adaptation of a deep learning model of the present invention.

The computing device 1000 may include a user interface module 1001, a network communication module 1002, one or more processors 1003, data storage 1004, one or more cameras 1018, one or more sensors 1020, and a power system 1022, all of which may be interconnected via a system bus, network, or other connection mechanism 1005.

The user interface module 1001 may be operable to transmit data to and/or receive data from external user input/output devices.

For example, in the present invention, receiving, by the deep learning model real-time adaptation system 100, training data may performed by an external input using the user interface module. In this case, the user interface module 1001 may include a touchscreen, computer mouse, keyboard, keypad, touchpad, trackball, joystick, voice recognition module, or other similar devices.

In addition, the user interface module 1001 may also be configured to provide output to one or more user display devices, such as a cathode ray tube (CRT), liquid crystal display (LCD), light-emitting diode (LED), display using digital light processing (DLP) technology, or a printer. The user interface module 1001 may also be configured to generate audible output using devices such as speakers, speaker jacks, audio output ports, audio output devices, earphones, and/or other similar devices.

The user interface module 1001 may further configured with one or more haptic devices capable of generating tactile output, such as vibration and/or other forms of output, detectable by touch and/or physical contact with the computing device 1000.

The network communication module 1002 may include one or more devices that provide one or more wireless interfaces 1007 and/or one or more wired interfaces 1008, which can be configured to communicate over a network.

In addition, the network communication module 1002 may be configured to provide secure and/or authenticated communication that is reliable.

The one or more processors 1003 may include one or more general-purpose processors and/or one or more special-purpose processors (e.g., digital signal processors, tensor processing units (TPUs), graphics processing units (GPUs), neural processing units (NPUs), application-specific integrated circuits (ASICs), or application-specific semiconductors, etc.). The one or more processors 1003 may be configured to execute computer-readable instructions 1006 included in the data storage 1004 and/or other commands described in the present specification.

As such an example, the training and inference described in the present specification may be executed on a neural processing unit (NPU) to enhance efficiency by performing data calculation processing with high speed and low power consumption.

The data storage 1004 may include one or more non-transitory computer-readable storage media that are readable and/or accessible by at least one of the one or more processors 1003.

The one or more computer-readable storage media may include volatile and/or non-volatile storage constituent elements, such as optical, magnetic, organic, or other memory or disk storage devices. In some examples, the data storage 1004 may be implemented using a single physical device (e.g., one optical, magnetic, organic, or other memory or disk storage device), whereas in other examples, the data storage 1004 may be implemented using two or more physical devices.

The data storage 1004 may include computer-readable instructions 1006 as well as additional data. The data storage 1004 may include storage necessary to perform at least part of the methods, scenarios, and technologies described in the present specification and/or at least part of the functions of the devices and networks.

In some examples, the data storage 1004 may include a storage for the trained neural network model 1010 described in the present invention (e.g., deep learning model and teacher model).

Meanwhile, the computing device 1000 may include one or more cameras 1018, one or more sensors 1020, and/or a power system 1022.

The camera(s) 1018 may capture light and/or electromagnetic radiation emitted as visible light, infrared radiation, ultraviolet light, and/or one or more other frequencies of light. The sensor 1020 may be configured to measure conditions within the computing device 1000 and/or conditions in the environment of the computing device 1000 and provide data regarding these conditions. The power system 1022 may include one or more batteries 1024 and/or one or more external power interfaces 1026 to provide power to the computing device 1000.

Meanwhile, the above description explains the implementation of the deep learning model real-time adaptation system 100 of the present invention as a computing device, but the present invention is not limited thereto. For example, the functionality of the neural network and/or computing device may be distributed among a plurality of computing clusters.

Further, the present invention described above may be implemented as a program executed by one or more processes in an electronic device and stored on a computer-readable recording medium.

Therefore, the present invention may be implemented as computer-readable code or instructions on a medium in which the program is recorded. That is, the various control methods according to the present invention may be provided in the form of a program, either in an integrated or individual manner.

Meanwhile, the computer-readable medium includes all kinds of storage devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, and optical data storage devices.

Further, the computer-readable medium may be a server or cloud storage that includes storage and that the electronic device is accessible through communication. In this case, the computer may download the program according to the present invention from the server or cloud storage, through wired or wireless communication.

Further, in the present invention, the computer described above is an electronic device equipped with a processor, that is, a central processing unit (CPU), and is not particularly limited to any type.

Meanwhile, it should be appreciated that the detailed description is interpreted as being illustrative in every sense, not restrictive. The scope of the present invention should be determined on the basis of the reasonable interpretation of the appended claims, and all of the modifications within the equivalent scope of the present invention belong to the scope of the present invention.

What is claimed is:

1. A method of real-time adaptation of a deep learning model using a system for real-time adaptation of a deep learning model, the method comprising:
receiving training data further provided for a pre-trained deep learning model;
identifying, among a plurality of blocks included in the deep learning model, one or more blocks having a learning impact due to entropy change that is less than a predetermined level;
training the one or more blocks using the training data so that entropy for a class corresponding to the training data is minimized; and
retraining the deep learning model using the training data based on a pre-trained teacher model.

2. The method of claim 1, wherein the one or more blocks having a learning impact due to entropy changes that is less than a predetermined level are selected by performing training on each of the plurality of blocks individually so that entropy for the deep learning model is minimized during pre-training process before the deep learning model is deployed.

3. The method of claim 1, wherein the one or more blocks having a learning impact due to entropy changes that is less than a predetermined level are selected based on a comparison result between data output from the deep learning model that has been pre-trained and data output from a model in which an arbitrary one block of the plurality of blocks is trained such that entropy is minimized.

4. The method of claim 1, wherein the identifying of the one or more blocks includes:
calculating a first prototype vector from pre-training data based on a deep learning model;
calculating a second prototype vector from noise training data with noise inserted into the pre-training data, based on a deep learning model in which the one or more blocks are trained so that entropy is minimized among a plurality of blocks; and
calculating a similarity between the first prototype vector and the second prototype vector, and selecting, based on the calculated similarity, the one or more blocks having a learning impact due to the entropy minimization that is less than a predetermined level.

5. The method of claim 1, wherein the retraining of the deep learning model includes:
generating a training data pair by replicating the training data;
acquiring output data for the training data pair using a teacher model; and
training the deep learning model by labeling the acquired output data on the training data as pseudo ground truth data.

6. The method of claim 5, wherein the generating of the training data pair includes:
replicating the training data to generate replicated data;
performing image processing on the replicated data; and
generating a training data pair based on the replicated data on which the image processing has been performed and the training data.

7. The method of claim 5, wherein the acquiring of the output data includes:
inputting the training data according to the training data pair into the teacher model to acquire first output data;
inputting the replicated data, in which image processing according to the training data pair has been performed, into the teacher model to acquire second output data; and
calculating the output data for the training data pair based on the first output data and the second output data.

8. The method of claim 5, wherein the training of the deep learning model includes:
labeling the output data generated by the teacher model for the training data pair on the training data as the pseudo ground truth data; and
training the plurality of blocks included in the deep learning model using the training data and the pseudo ground truth data.

9. A system for real-time adaptation of a deep learning model, comprising:
an input unit configured to receive training data further provided for a pre-trained deep learning model; and
a control unit configured to perform further training of the deep learning model using the training data,
wherein the control unit configured to:
identify one or more blocks, among a plurality of blocks included in the deep learning model, where a learning impact due to entropy changes is less than a predetermined level;
train the one or more blocks using the training data so that entropy corresponding to a class corresponding to the training data is minimized; and
retrain the deep learning model using the training data based on a pre-trained teacher model.

10. A program stored on a computer-readable recording medium, and executed by one or more processes in an electronic device, the program comprising instructions to allow the program to perform:
receiving training data further provided for a pre-trained deep learning model;
identifying, among a plurality of blocks included in the deep learning model, one or more blocks having a learning impact due to entropy change that is less than a predetermined level;
training the one or more blocks using the training data so that entropy for a class corresponding to the training data is minimized; and
retraining the deep learning model using the training data based on a pre-trained teacher model.
